(19) United States
(12) Patent Application Publication
(10) Pub. No.: US 2003/0223319 A1
(43) Pub. Date: Dec. 4, 2003

(54) Optical disc player providing user-management function for MP3 files and method thereof

(75) Inventor: Eun-mi Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/367,957

(22) Filed: Feb. 19, 2003

(30) Foreign Application Priority Data
Feb. 19, 2002 (KR) 2002-8754

(51) Int. Cl. G11B 7/085

(52) U.S. Cl. 369/30.07; 369/59.25

(57) ABSTRACT

An optical disc player providing a management function for a user's MP3 files and a method thereof includes a file management control unit which generates specific directories designated by a user and lists files selected by the user in the directories from the files included in an MP3 file storing medium, and also includes a directory storing unit, which stores the specific directories and the files listed in the directories. Accordingly, the optical disc player provides a function of generating a file structure for the user's convenience and another function of re-naming file names so that the user can conveniently manage the files.

### CROSS-REFERENCE TO RELATED APPLICATIONS

This application claims the priority of Korean Patent Application No. 2002-8754, filed Feb. 19, 2002, in the Korean Intellectual Property Office, which is incorporated herein in its entirety by reference.

### BACKGROUND OF THE INVENTION

1. Field of the Invention

The present invention relates to an optical disc player, and more particularly, to an optical disc player providing a user-management function for MP3 files, grouping the MP3 files according to a user preference, and re-naming the MP3 files, and a method thereof.

2. Description of the Related Art

MP3, as a kind of a coding compression standard, has been widely used due to its capability of using a small storing capacity to store a large amount of data by a high compression rate and securing high-quality sounds when being reproduced. In addition, MP3 players have also been widely used along with MP3 data.

However, a conventional optical disc player includes only a reproducing function and a repeat function with respect to management of the MP3 data or MP3 files.

When it is assumed that one MP3 file corresponds to a piece of music or a song, the optical disc player can reproduce a lot of the MP3 files. For example, one storing medium can include more than 200 directories and 400 files.

FIG. 1 is an example of a user interface window for reproducing MP3 files in a conventional optical disc player.

Here, the user interface window of the conventional optical disc player includes a file display window 100 for displaying the MP3 files read from a recording medium. In FIG. 1, the MP3 files are displayed as respectively corresponding numbers, for example, “01 02 03 04 . . . 399 400”. In addition, the user interface window of the conventional optical disc player includes a program window 110, which provides a user input interface function, allowing a user to use a predetermined reproduction editing function. Accordingly, the user can see all of the MP3 files, which are read from the recording medium, via the file display window 100 and select files from the read MP3 files to be displayed on the program window 110. Thus, the optical disc player reproduces or repeats the reproduction of the selected files, which are displayed on the program window 110, according to commands from the user. However, a file list of the selected MP3 files can only be stored temporarily. In other words, when the program window 110 is closed, the power of the optical disc player is reset, or a tray of the recording medium in the optical disc player is open, the file list displayed on the program window 110 is erased. In addition, a new file can only be added to the file list as a last file while a function of determining an order of the files is not provided. Furthermore, a grouping or listing function of the MP3 files, which is provided by the optical disc player for reproducing the MP3 files using the program window 110 of FIG. 1, permits only one group or list of MP3 files to be displayed on the program window 110 of FIG. 1. Accordingly, the provided management function for the user's MP3 files is not sufficient to organize the MP3 files.

Here, the window shown in FIG. 1 is only an example, and the conventional optical disc player may display names of the MP3 files using characters instead of numbers. For example, when an MP3 storing medium includes a directory of LeeSuYoung, which has files of Leesuyoung_i believe.mp3 and Leesuyoung_and love you.mp3, the optical disc player should display the MP3 file names on the user interface window, i.e., the file display window 100 of FIG. 1, as follows.

LeeSuYoung-Leesuyoung_i believe

Leesuyoung_and love you

However, the conventional optical disc player cannot support sufficient fonts to display the MP3 file names and the directories thereof. Accordingly, the directory names and the file names included in the directories are displayed on the user interface window of the optical disc player in a broken state so that the user cannot recognize the directory names and the file names.

As described above, since the conventional optical disc player does not provide sufficient interface functions or editing functions, further additional user interface functions are required to edit the MP3 files, such as re-naming the MP3 file names, and generate folders or directories to group the MP3 files therein.

### SUMMARY OF THE INVENTION

The present invention provides an optical disc player providing a user-management function for MP3 files that allows a user to selectively group the MP3 files, and a method thereof.

The present invention also provides an optical disc player providing a user-management function for MP3 files that allows a user to re-name the MP3 files or directories, and a method thereof.

Additional aspects and advantages of the invention will be set forth in part in the description which follows and, in part, will be obvious from the description, or may be learned by practice of the invention.

According to an aspect of the present invention, an optical disc player reproducing MP3 files includes a file management control unit, which generates specific directories designated by a user and lists files selected by the user in the directories from the files included in an MP3 file storing medium, and a directory storing unit, which stores the specific directories and the files listed in the directories.

It is possible that the number of the directories is at least one, and the directories are stored with sub files.

It is possible that the optical disc player further includes a user input/output interface unit, which generates the directories, selects the files, and displays the selected files.

It is possible that the file management control unit provides a re-naming function to the user input/output interface unit so that the user re-names the directories and files when a predetermined directory and the files listed in the directory are displayed.

According to another aspect of the present invention, there is provided a method of managing MP3 files in an optical disc player, which reproduces MP3 formatted data files, includes reading a recording medium, displaying MP3 data in unit of a file unit, generating predetermined directories, and listing and storing the MP3 files selected by a user in the directories.

It is possible that plural numbers of the directories and file lists corresponding to the directories are formed.

It is possible that the method further includes re-naming the MP3 files and the directories by the user.

It is possible that the method further includes classifying the MP3 files according to a generated and stored directory structure and displaying the classified MP3 files.

According to another aspect of the present invention, an optical disc player for reproducing MP3 files includes a unit which provides a first function of displaying the MP3 files read from a recording medium and directories thereof and a second function of allowing a user to re-name the directories and the MP3 files.

According to another aspect of the present invention, a method of managing MP3 formatted data files in an optical disc player, which reproduces the MP3 data files from a recording medium including the MP3 data files, includes reading the recording medium, displaying names of the MP3 files or directories thereof, and allowing a user to correct or rename the names of the directories and MP3 files.

It is possible that the method provides a predetermined font to re-name the directories and the files.

It is possible that the predetermined font is English language font.

### BRIEF DESCRIPTION OF THE DRAWINGS

The above and/or other aspects and advantages of the present invention will become more apparent and more readily appreciated from the following description of the preferred embodiment, taken in conjunction with the accompanying drawings of which:

FIG. 1 is an MP3 management user interface window of a conventional optical disc player;

FIG. 2 is a schematic diagram illustrating an optical disc player including an MP3 file management function according to an embodiment of the present invention;

FIGS. 3A and 3B are examples of user interface windows relating to MP3 files of the optical disc player shown in FIG. 2; and

FIG. 4 is a flowchart illustrating a method of managing files in the optical disc player, which reproduces MP3 formatted data files, shown in FIG. 2.

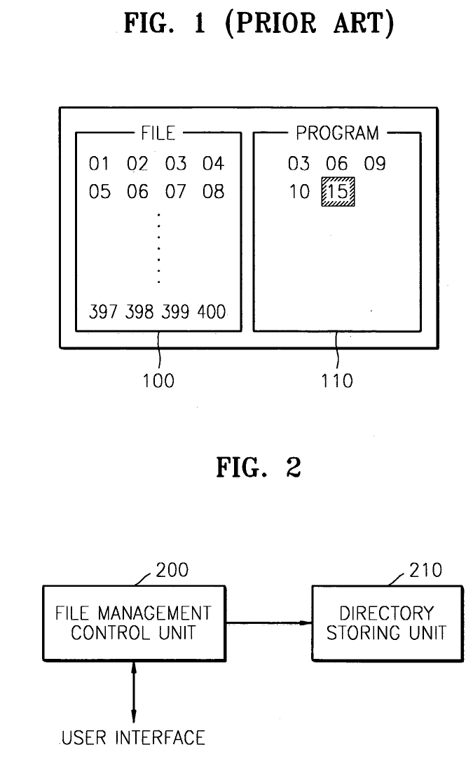

### DETAILED DESCRIPTION OF THE PREFERRED EMBODIMENTS

Reference will now be made in detail to the present preferred embodiment of the present invention, examples of which are illustrated in the accompanying drawings, wherein like reference numerals refer to the like elements throughout. The embodiment is described in order to explain the present invention by referring to the figures.

FIG. 2 is a schematic diagram illustrating an optical disc player managing MP3 files according to an embodiment of the present invention. Here, the diagram of FIG. 2 illustrates elements relating to the management of the MP3 files, and descriptions of the elements and the drawings directly relating to reproduction of data files are omitted. Each MP3 file represents a piece of music or song, an MP3 formatted data file, or a file reproduced in the optical disc player or a computer and an MP3 player compatible with the optical disc player.

The optical disc player managing the MP3 files includes a file management control unit 200 and a directory storing unit 210.

The file management control unit 200 generates directories, which are designated by a user, and file lists, which will be included in the directories. In this case, the user may generate a file list containing the MP3 files read by the optical disc player, for example, according to genres, such as jazz. The user inputs a command to generate a jazz directory by using a predetermined interface unit of the optical disc player. Thus, the file management control unit 200 generates the directory according to the command generating directories. Here, a name of the directory can be a number automatically set by the optical disc player or a title, such as jazz, which has been input by the user. When the directories are generated, the user selects the MP3 files, which will be included in the directories. For example, the user can select the MP3 files, which will be included in the jazz directory. The file management control unit 200 lists or groups the MP3 files selected by the user, as sub items in the corresponding directory. Here, a plurality of the directories and sub items can be generated. For example, the file management control unit 200 provides a function of generating the directories, such as classic, rock, jazz, and rhythm and blues, and another function of listing the sub files corresponding to the directories.

The directory storing unit 210 stores the directories and the file lists generated in the file management control unit 200. Here, unlike a conventional optical disc player, the directory storing unit 210 can maintain information on the directories and the file lists corresponding to the directories, according to a selection of the user. In order to store the directories and the file lists corresponding to the directories, the information can be recorded in an empty region of a recording medium, such as an optical disc or the MP3 player, including the MP3 files or overwritten on an initial directory structure of the recording medium. In another case, the information can be stored in a memory of the optical disc player. When the information is stored in the memory of the optical disc player, the information should include identification information on the recording medium including the MP3 files or a directory structure of the MP3 files. Accordingly, in a case where the identification information on the recording medium is identical with the identification information stored in the memory, when the recording medium whose directory structure is stored in the memory of the optical disc player is reproduced, the optical disc player displays the MP3 files by using the directory structure, which has been stored in the memory.

In addition, the optical disc player can provide a function of erasing the directories or MP3 files by a directory unit or a file unit as well as the function of generating the directories of the MP3 files.

In order to generate the directories and generate and erase the file lists of the directories, the optical disc player requires a user interface unit (not shown), which receives user inputs and displays a result of the user inputs.

According to a file structure of the MP3 files, the user generates desired classification items, i.e., directories, and lists the MP3 files in the classification items, i.e., groups the MP3 files, to manage the MP3 files according to a user preference. In addition, the user may perform several additional functions, such as reproducing the files in the selected directory, by using the file structure.

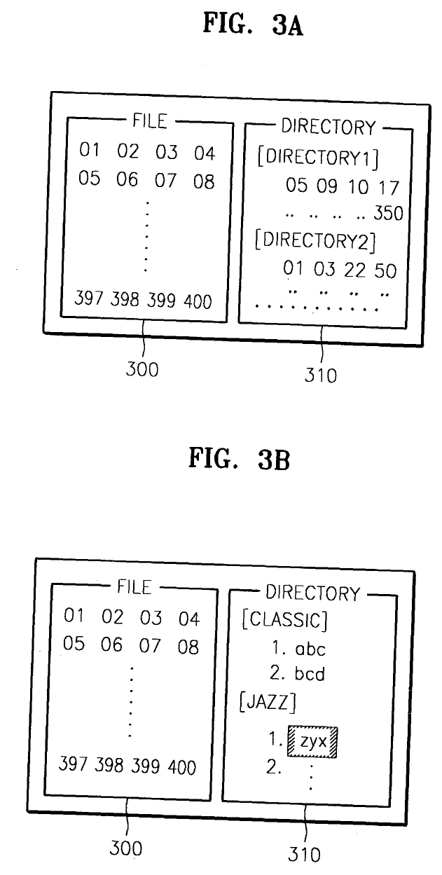

FIGS. 3A and 3B are examples of user interface windows of the optical disc player shown in FIG. 2. Here, a left window 300 of FIG. 3A displays MP3 data stored in the recording medium by the file unit. A right window 310 of FIG. 3A displays the directories generated by the user and the file lists included in the directories. FIG. 3B is an example of re-naming the directories and the MP3 files by the user using the user interface window.

In general, the MP3 files of the recording medium include additional information, such as names. However, a great number of MP3 file names are displayed by numbers or by characters, such as “? [symbol] **?,” which cannot be recognized by the user, on the optical disc player due to a limitation in the fonts of the optical disc player or the limitation in a memory capacity allotted to a display of MP3 file names. The optical disc player has a function of re-naming the MP3 files read from the recording medium. Accordingly, the user changes the directory names and the file names into signs, which can be easily recognized by the user, so that the user can easily recognize the directories and the MP3 files. To this end, the optical disc player should include a predetermined unit (not shown) having such a re-naming function. The re-named file names and directory names can be recorded or overwritten on the corresponding recording medium or can be stored in the memory of the optical disc player along with the information on the directories and file lists.

In addition, the fonts, which will be used by the user, should be prepared in the optical disc player. In this case, it is possible that the optical disc player uses English language fonts, which require a small amount of the memory capacity.

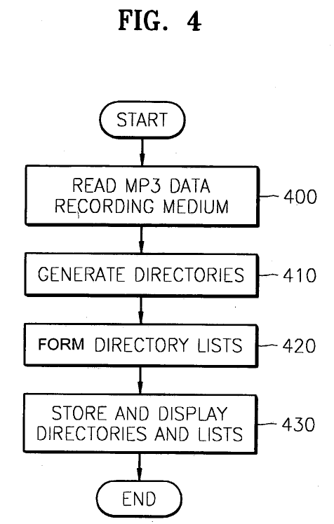

FIG. 4 is a flowchart illustrating a method of managing files in the optical disc player reproducing the MP3 data files.

First, the optical disc player reads the recording medium including the MP3 data files and displays the MP3 data file structure in operation 400. Here, the user may re-name the MP3 files and the directories by using specific keys or the user interface unit, such as a graphic user interface (GUI), which is provided by the optical disc player.

When the user inputs a command of generating a specific folder or directory by using the user interface unit, the optical disc player generates folders or directories according to the command from the user in operation 410. Here, the user may name the folders or the directories.

When the user selects the MP3 files to be included in the folders or the directories, the optical disc player lists the MP3 files to be included in the folders or the directories, in operation 420. Thereafter, the optical disc player stores and displays the folders or the directories and the directory lists in operation 430. Here, the directories and the directory lists can be stored in the memory of the optical disc player or on the recording medium including the corresponding files.

As described above, the optical disc player provides functions of generating the file structure for the user's convenience and re-naming the file names so that the user can conveniently manage the files.

While this invention has been particularly shown and described with reference to a preferred embodiment thereof, it will be understood by those skilled in the art that various changes in form and details may be made therein without departing from the spirit and scope of the invention as defined by the appended claims and their equivalents.

What is claimed is:

1. An optical disc player reproducing MP3 files, the optical disc player comprising:
a file management control unit, which generates a plurality of directories assigned by a user and lists the MP3 files selected by the user in the directories from an MP3 file storing medium; and
a directory storing unit, which stores the directories and the MP3 files listed in the directories.

2. The optical disc player of claim 1, wherein the number of directories is at least two, and the directories are stored with sub files corresponding to the MP3 files.

3. The optical disc player of claim 1, further comprising:
a user input/output interface unit, which generates the directories, selects the MP3 files, and displays the selected MP3 files.

4. The optical disc player of claim 3, wherein the file management control unit provides a re-naming function to the user input/output interface unit to enable the user to rename the directories and the MP3 files when one of the directories and the files listed in the one directory are displayed through the user input/output interface unit.

5. A method of managing MP3 files in an optical disc player, which reproduces MP3 formatted data files, the method comprising:
reading a recording medium and displaying the MP3 files in unit of a file;
generating a plurality of directories; and
listing and storing the MP3 files selected by a user in the corresponding directories.

6. The method of claim 5, wherein the listing and storing of the MP3 files comprises:
forming file lists corresponding to the directories.

7. The method of claim 5, further comprising:
re-naming of the MP3 files and the directories.

8. The method of claim 5, further comprising:
classifying the MP3 files according to a structure representing the generated and stored directories; and
displaying the classified MP3 files.

9. An optical disc player reproducing MP3 files, the optical disc player comprising:
a unit which provides a first function of displaying the MP3 files read from a recording medium and directories thereof and a second function of allowing a user to re-name the directories and the MP3 files.

10. The optical disc player of claim 9, wherein the unit provides a font to re-name the directories and the files.

11. The optical disc player of claim 10, wherein the font is an English language font.

12. A method of managing MP3 files in an optical disc player, which reproduces the MP3 files from a recording medium including the MP3 files, the method comprising:
reading the recording medium and displaying the MP3 files and directory structure thereof; and
allowing a user to correct or re-name names of the directories and the MP3 files.

13. The method of claim 12, wherein the renaming of the names comprises:
providing a font to re-name the directories and the MP3 files.

14. The method of claim 13, wherein the font is an English language font.

15. An optical disc player reproducing MP3 files from a recording medium, comprising:
a file management control unit forming first and second directories, forming a first list of first MP3 files in the first directory, and forming a second list of second MP3 files, which are different from the first MP3 files, in the second directory; and
a directory storing unit storing the first and second directories and the first and second MP3 files listed in the first and second directories.

16. The optical disc player of claim 15, wherein the file management control unit generates a directory structure, which represents the first and second directories, to be stored in one of the directory storing unit and the recording medium.

17. The optical disc player of claim 16, wherein the recording medium stores a reference structure, and the file management control unit generates a directory structure, which represents the first and second directories, from the directory storing unit, reads the reference structure from the recording medium, compares the directory structure with the reference structure of the recording medium, and modifies the first and second directories when the directory structure is identical to the reference structure.

18. The optical disc player of claim 17, wherein the file management control unit generates a second directory structure representing the modified first and second directories and overwrites the second directory structure on the reference structure of the recording medium as a new reference structure.

19. The optical disc player of claim 17, wherein the first and second MP3 files comprises respective names, and the file management control unit re-names one of the names of the first and second MP3 files when the directory structure is identical to the reference structure.

20. The optical disc player of claim 15, wherein the first and second MP3 files comprises respective names, and the file management control unit modifies one of the names of the first and second MP3 files.

21. The optical disc player of claim 20, wherein each name of the first and second MP3 files in the first and second lists is formed using an English language font.

22. The optical disc player of claim 15, wherein the file management control unit generates a directory structure, which represents the first and second directories and the first and second lists, to be stored in one of the directory storing unit and the recording medium.

23. The optical disc player of claim 15, wherein the number of the first MP3 files and the number of the second MP3 files are equal to or less than a total number of the MP3 files.

24. The optical disc player of claim 15, wherein the directory storing unit comprises:
a memory disposed in the optical disc player.

25. The optical disc player of claim 15, wherein the directory storing unit comprises:
an external memory disposed in an outside of the optical disc player.

26. The optical disc player of claim 15, wherein the recording medium comprises:
one of an optical disc and an MP3 player.

27. The optical disc player of claim 15, further comprising:
a display, wherein the file management control unit displays the first and second directories and the first and second lists on the display.

28. The optical disc player of claim 27, wherein the display is mounted on the optical disc player.

29. The optical disc player of claim 27, wherein the display is disposed in an outside of the optical disc player and coupled to the optical disc player using a signal line.

30. An optical disc player reading data from a recording medium, comprising:
a file management control unit reading from the recording medium a file structure representing first and second directories, first MP3 files included in the first directory, and second MP3 files included in the second group directory; and
a display unit displaying the first and second directories and the first and second MP3 files.

31. The optical disc player of claim 30, further comprising:
a directory storing unit storing the first and second directories and the first and second MP3 files.

32. The optical disc player of claim 30, further comprising:
a directory storing unit storing a reference structure, the first and second directories, and first and second lists representing the first and second MP3 files, respectively, wherein the file management control unit compares the reference structure with the file structure and controls the display unit to display the first and second directories and the first and second lists stored in the directory storing unit.

33. The optical disc player of claim 32, wherein the file management control unit modifies one of names of the first and second directories and the first and second MP3 files listed in the first and second lists.

34. An optical disc player reading data from a recording medium, comprising:
a file management control unit reading from the recording medium a first directory and a first list representing first MP3 files included in the first directory, and forming a second directory and forming a second list representing second MP3 files included in the second directory; and
a display unit displaying the first and second directories and the first and second lists.

35. The optical disc player of claim 34, wherein the file management control unit stores the first and second group directories and the first and second lists in the recording medium.

36. The optical disc player of claim 34, wherein the recording medium comprises:
one of an optical disc and an MP3 player.

37. The optical disc player of claim 34, further comprising:
a directory storing unit disposed in the optical disc player, wherein the file management control unit stores the first and second directories and the first and second lists in the directory storing unit.

38. The optical disc player of claim 34, wherein the file management control unit forms a directory structure representing the first directory, the first list representing the first MP3 files included in the first directory, the second directory, and the second list representing the second MP3 files included in the second directory.

39. The optical disc player of claim 38, wherein the file management control unit stores the directory structure in the recording medium.

40. A method in an optical disc player reproducing MP3 files from a recording medium, comprising:
forming first and second directories;
forming a first list of first MP3 files included in the first directory and a second list of second MP3 files, which are different from the first MP3 files, included in the second group directory; and
storing the first and second directories and the first and second lists in one of the recording medium and a memory of the optical disc player.

41. A method in an optical disc player reading data from a recording medium, comprising:
reading from the recording medium a file structure representing first and second directories, first MP3 files included in the first directory, and second MP3 files included in the second directory; and
displaying the first and second directories and the first and second MP3 files.

42. A method in an optical disc player reading data from a recording medium, comprising:
reading from the recording medium a first directory and a first list representing first MP3 files included in the first directory;
forming a second directory and forming a second list representing second MP3 files, which is different from the first MP3 files, included in the second directory; and
displaying the first and second group directories and the first and second lists in a display.

43. A recoding medium encoded with data readable by a computer to implement a method of displaying MP3 files, the medium comprising:
a directory structure data used to represent directories and the MP3 files included in the corresponding ones of the directories.

44. The recoding medium of claim 43, wherein the computer comprises:
one of an MP3 player and an optical disc player.

45. The recoding medium of claim 43, wherein the computer comprises a terminal and transmits the directory structure to an outside of the computer through the terminal.
